(19) United States
(12) Patent Application Publication
(10) Pub. No.: US 2008/0307879 A1
(43) Pub. Date: Dec. 18, 2008

(54) Method for Control of a Thermal/Calorimetric Flow Measuring Device

(75) Inventors: Walter Borst, Fachingen (DE); Oliver Popp, Fislisbach (DE)

Correspondence Address: BACON & THOMAS, PLLC, 625 SLATERS LANE, FOURTH FLOOR, ALEXANDRIA, VA, 22314-1176, US

(73) Assignee: ENDRESS & HAUSER FLOWTEC AG, REINACH (CH)

(21) Appl. No.: 11/795,038

(22) PCT Filed: Dec. 16, 2005
(86) PCT No.: PCT/EP05/56855

§ 371 Date: Aug. 22, 2008

(30) Foreign Application Priority Data
Jan. 13, 2005 (DE) 10-2005-001-809.2

(51) Int. Cl. G01F 1/68; G06F 15/00

(52) U.S. Cl. 73/204.11; 702/130

(57) ABSTRACT

A method for control of a thermal, or calorimetric, flow measuring device, which ascertains and/or monitors, by means of two temperature sensors, the flow of a measured medium through a pipeline or measuring tube in a process, wherein the current temperature (Tᵢ) of the measured medium is ascertained at a point in time (tᵢ) via a first temperature sensor, wherein, to a second temperature sensor, a defined heating power is supplied, which is so sized that a predetermined temperature difference (Θ_{target}) occurs between the two temperature sensors, and wherein, in the case of a deviation (Θ_{target}−Θᵢ) of the current temperature difference Θᵢ measured in the actual-state from the temperature difference (Θ_{target}) predetermined for the target-state, at a following point in time (tᵢ₊₁) , the heating power (Qᵢ₊₁) supplied to the heatable temperature sensor is ascertained The heating power (Qᵢ₊₁) is determined taking into consideration physical conditions in the process, as such are reflected in a time constant (τ).

The invention relates to a method for control of a thermal/calorimetric flow measuring device, which ascertains and/or monitors, by means of two temperature sensors, the flow, e.g. flow rate, of a measured medium flowing through a pipeline or through a measuring tube in a process, wherein the current temperature of the measured medium is ascertained at a point in time via a first temperature sensor and wherein to a second temperature sensor a defined heating power is fed, whose level is so selected that a predetermined temperature difference occurs between the two temperature sensors.

Usually a PID controller is applied for controlling the heatable temperature sensor. Usually, for the control method, control parameters are selected, which have been determined earlier under defined physical conditions in a process. An essential variable among the physical conditions in the process is the flow rate of the measured medium flowing through the flow measuring device. The physical conditions in the process are reflected largely in a heat transfer coefficient, which characterizes the heat transfer from the temperature sensor to the measured medium.

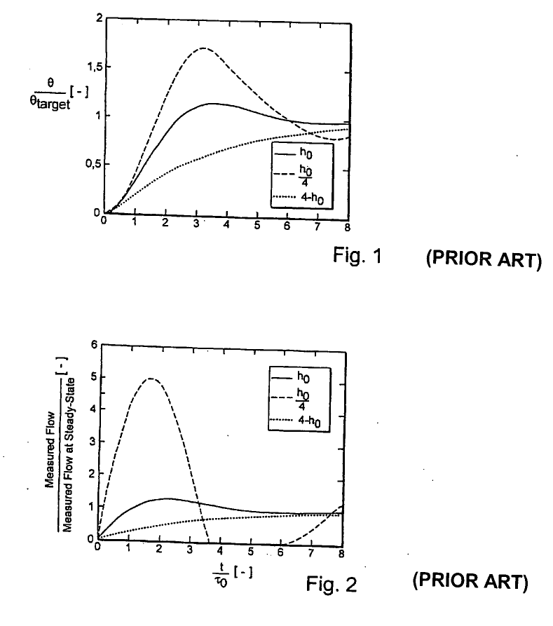

FIGS. 1 and 2 illustrate the readjustment of a typical, conventional, thermal flow measuring device, following a change of the setpoint, or target, temperature. A change of the target temperature corresponds to a temperature jump, which initiates a control process. Ideally, the reaction of the flow measuring device corresponds to the solid line. Here, h₀ is the heat transfer coefficient in the case of defined conditions in the process, thus e.g. in the case of a predetermined flow rate of the measured medium through the pipeline. Readjustment following the temperature jump is relatively rapid (FIG. 1). The flow measuring device delivers, almost immediately, measured values, which reliably represent the flow rate of the measured medium through the pipeline (FIG. 2).

If, however, the measured medium flows through the pipeline with a velocity, which effects a heat transfer coefficient four times as large as in the previously mentioned case, then the response to the jump shows a less ideal behavior. This case is shown in FIGS. 1 and 2 with the dotted lines. It takes a relatively long time, until the target temperature of the system ‘temperature-sensor, measured-medium’ is reached; the same is true also for the flow measurement values provided in parallel: Over a relative long period of time, the flow measuring device delivers measurement values which are too low. One can say, that the current value creeps toward the target.

The opposite case is shown in the two figures on the basis of the dashed curve. Here, the heat transfer coefficient is only a fourth (h₀/4) of the case characterized by the value h₀, for which the control is optimized. The reaction to the temperature jump exhibits an over-reaction of the system: Since the temperature sensor receives the same heating-power as in the case of the four times larger flow rate, the control displays an overshooting. Also here it takes a relatively long time until the desired constant target temperature value is achieved. The reaction of the control unit reflects itself again also in varying measurement values issued by the flow measuring device during the control process. On the basis of the presentations in FIGS. 1 and 2, it is thus made clear that a thermal flow measuring device, which is operated via a control process not reflecting the current physical conditions reigning in the process, can show a relatively high measurement inaccuracy.

An object of the invention is to provide a method for rapid and stable control of a thermal flow measuring device under the most varied of process conditions.

The object is achieved by the features that, in the case of a deviation of the current temperature difference measured in the actual-state from the temperature difference predetermined for the desired-, or target-state, at a subsequent point in time, the heating power fed to the heatable temperature sensor is ascertained, wherein the heating power is ascertained taking into consideration the physical conditions in the process, as such are reflected in a time constant.

In an advantageous further development of the method of the invention, the time constant reflecting the physical conditions in the process is determined via the following estimate:

$$τ ∝ \frac{{θ}_{target}}{{Q}_{i}} [ sec ]$$

wherein
θ_{target} is the predetermined temperature difference between heated temperature sensor and unheated temperature sensor, in [° C.], and
Qᵢ is the heating power in [W], i.e. in watts, fed to the heated sensor at the point in time tᵢ.

Alternatively, the time constant reflecting the physical conditions in the process is determined via the following estimate:

$$τ ∝ \frac{{θ}_{i}}{{Q}_{i}} [ sec ] .$$

wherein
θᵢ is the current temperature difference between heated and unheated temperature sensor, in [° C.], and
Qᵢ is the heating power [W] fed to the heated sensor at the point in time tᵢ.

In an advantageous embodiment of the method of the invention, in the case, wherein the current temperature difference measured in the actual-state deviates from the temperature difference predetermined for the target-state, the rate of change for the feeding of the heating power for compensating the deviation is determined such that the system reaches the target-state as rapidly as possible.

Preferably, the rate of change for reaching the target-state is calculated via the following estimation:

$${( \frac{\partial θ}{\partial t} )}_{target} = \frac{{θ}_{target} - {θ}_{i}}{τ}$$

In an advantageous embodiment of the method of the invention, in the case wherein the current temperature difference measured in the actual-state deviates from the temperature difference predetermined for the target-state, the rate of change for the feeding of the heating power is calculated according to the following formula:

$${Q}_{i + 1} = {Q}_{i} - {c}_{1} \cdot Δ t \cdot ( ( \frac{{θ}_{i} - {θ}_{i - 1}}{Δ t} ) - ( \frac{{θ}_{target} - {θ}_{i}}{τ} ) ) .$$

wherein c₁, in [W·s/K], represents a proportionality constant dependent on the controller being used, and
Δt is the length of time, in [s], between two measurements following one after the other.

The invention will now be explained in greater detail on the basis of the drawing, the figures of which show as follows:

FIG. 1 a graphical presentation of the reaction of a conventional control unit to a temperature jump in the case of different flow rates of the measured medium in the pipeline, or measuring tube;

FIG. 2 a graphical presentation of the measurement values delivered by a thermal flow measuring device on the basis of the control processes shown in FIG. 1;

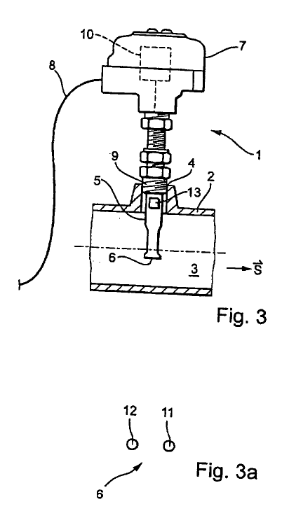

FIG. 3 a schematic representation of a thermal flow-measuring device for performing the method of the invention;

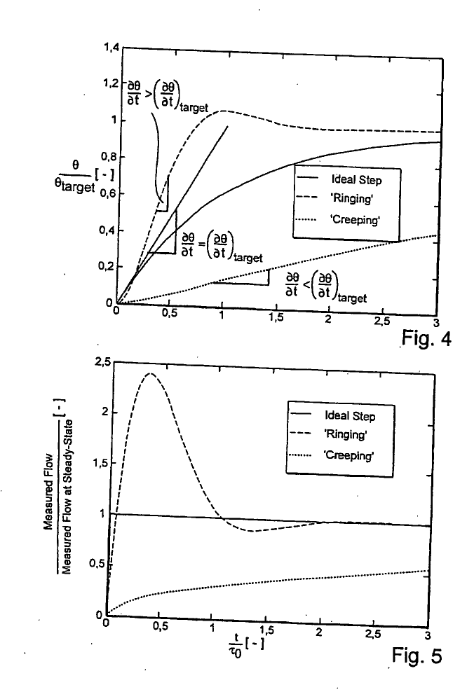

FIG. 4 a graphical presentation of different rates of change for reaching the target temperature difference; and

FIG. 5 a graphical presentation of measurement values delivered by a thermal flow-measuring device during the control processes shown in FIG. 4.

FIGS. 1 and 2 have already been discussed above. FIG. 3 is a schematic drawing of a thermal flow-measuring device 1 suited for performing the method of the invention. Flow measuring device 1 is secured by a screw thread 9 in a nozzle 4 situated on a pipeline 2. Located in the pipeline 2 is the flowing measured medium 3. Alternatively, it is possible to provide the flow measuring device 1 in an integrated measuring tube as an inline measuring device.

The temperature measuring element 6 is situated in the part of the housing 5 facing the measured medium 3. Operation of, and/or evaluation of the measurement signals delivered from, the two temperature sensors 11, 12 are/is done via the control/evaluation unit 10, which, in the illustrated case, is arranged in the transmitter 7. Via the connection 8, communications are effected with a remote control location not specially shown in FIG. 3.

At least one of the two temperature sensors 11, 12 can be an electrically heatable, resistance element, a so-called RTD sensor. Of course, in connection with the solution of the invention, also a usual temperature sensor, e.g. a Pt100 or a Pt1000 or a thermocouple, can be used, with which is associated a thermally coupled heating unit 13. The heating unit 13 is arranged in FIG. 3 in the housing 5 and thermally coupled to the heatable temperature sensor 11, 12, but is largely decoupled from the measured medium 3. The coupling, or decoupling, as the case may be, is done by filling the respective intermediate spaces with, respectively, thermally well conducting, and thermally poorly conducting, material. Preferably, these are materials, such as casting materials or potting compounds, which are put in place and then harden.

With the flow measuring device 1, it is possible to measure the flow continuously; alternatively, the flow measuring device 1 can be applied as a flow switch, which always shows a changed switch state, when at least one predetermined limit value is subceeded (fallen beneath) or exceeded.

Alternatively, both temperature sensors 11, 12 can be embodied to be heatable. Then the functions of the first and second sensors are assigned to the temperature sensors 11, 12 by the control/evaluation unit 10. For example, one option is to have the control/evaluation unit 10 operate the two temperature sensors 11, 12 alternately as the active and passive temperature sensors and to ascertain the flow measurement value via an averaging of the measurement values delivered by the two temperature sensors 11, 12.

A heatable temperature sensor can be described by means of a simplified model as follows:

$$\frac{\partial θ}{\partial t} + \frac{1}{τ} \cdot θ = \frac{Q}{m \cdot {c}_{p}} \qquad ( 1 )$$

wherein
Q is the amount of heat, in [W], fed to the temperature sensor,
θ is the temperature difference of the temperature sensor relative to the temperature of the measured medium, in [K],
t is time, in [s], and
τ is the time constant of the temperature sensor.

The time constant τ is a measure of the inertia of the system ‘temperature-sensor, measured-medium’ in the face of changes in the process. Time constant τ can be described by the following formula:

$$τ = \frac{m \cdot {c}_{p}}{h \cdot A} \qquad ( 2 )$$

wherein
m is the mass of the temperature sensor, in [kg],
cₚ is the specific heat of the heated temperature sensor, in [J/(kg·K)],
A is the surface area of the sensor, in [m2], and
h is the external heat transfer coefficient, in [W/(m²·K)].

The first three quantities are, it is true, constant, but their exact values are usually not known. The heat transfer coefficient h is, moreover, dependent on the reigning physical conditions in the process, or system. An exact calculation of the time constant τ is thus not possible.

Ideally, the flow measuring device 1 reacts to every jump-like change in the physical conditions likewise with a jump-like change, as already indicated in connection with the description of FIG. 1. This means that the heat quantity fed to the temperature sensor 12 can ideally be represented as a step function (FIG. 5). In reality, such a reaction can only be achieved approximately, since the control/evaluation unit 10 does not know, in advance, the end conditions of the steady state exactly enough.

Under ideal conditions, i.e. an instantaneous, jump-like response of the heating power, the temperature θ would react as follows, wherein it is assumed that the system was at an earlier point in time t<0 in a steady-state condition.

Here, the following holds:

$$\begin{matrix}Q ( t ) = {Q}_{o} & for t < 0 and \\ θ ( t ) = {θ}_{o} = \frac{{Q}_{o}}{h \cdot A} & for t < 0\end{matrix} \qquad ( 3 )$$

A jump-like change in the physical conditions can be represented as follows:

Q(t)=Q₀+\hat{Q} for t≧0 (4)

The jump response of the temperature sensor 12 to this “heat jump” can be described as follows:

$$θ - {θ}_{o} = \frac{\hat{Q}}{h \cdot A} \cdot ( 1 - {e}^{- \frac{t}{τ}} ) \qquad ( 5 )$$

In case the jump in the heating power of the heating unit 13 correctly reflects the physical conditions, then the temperature approaches the target-temperature θ_{target}. This can be expressed mathematically by the following formula:

\hat{Q}=h·A·(θ_{target}−θ₀) (6)

Substituted into the formula (5), there results then the following equation:

$$θ - {θ}_{o} = ( {θ}_{target} - {θ}_{o } ) \cdot ( 1 - {e}^{- \frac{t}{τ}} ) \qquad ( 7 )$$

From this we learn that Equation (3) can be described by the temperature rise, as expressed mathematically in Equation (7). Thus, the temperature as expressed in Equation (7) is to be taken as the target temperature. This target temperature curve is characterized by the beginning rate of change: The rate of change is related to the rate of change for reaching the target temperature difference. This rate of change for reaching the target temperature difference is designated in the following as optimum rate of change.

$${( \frac{\partial θ}{\partial t} )}_{target} = \frac{{θ}_{target} - {θ}_{o}}{τ} \qquad ( 8 )$$

This subject matter is illustrated in FIG. 4 for the case (solid line) attainable by the method of the invention, for the case in which the rate of change is too small (dotted line), and for the case in which the rate of change is too great (dashed line).

FIG. 5 shows graphical presentations of the measurement values delivered by a thermal flow measuring device 1 during the control processes of FIG. 4. If the method of the invention is used, then the flow measuring device 1 delivers, within shortest time, a current, correct measurement value (solid line). If the rate of change, in contrast, is chosen too small (dotted line) or too great (dashed line), then a very long time is required for the system to reach equilibrium, whence the flow measuring device 1 can again deliver correct measurement values. Since the behavior of the system approximates the ideal state, application of the method of the invention permits the measurement accuracy of a flow measuring device 1 to be considerably improved during transient events.

The control algorithm of the invention is thus based on the facts that the current rate of change of temperature is closely connected with the optimal rate of change (as tuned to the particular process conditions) for reaching the target temperature.

An opportunity for implementation is thus, for the case, in which the current temperature difference Θᵢ measured in the actual-state deviates from the temperature difference Θ_{target} predetermined for the target-state, to calculate the rate of change for the feeding of the heating power Qᵢ₊₁ according to the following formula:

$${Q}_{i + 1} = {Q}_{i} - {c}_{1} \cdot Δ t \cdot ( ( \frac{{θ}_{i} - {θ}_{i - 1}}{Δ t} ) - ( \frac{{θ}_{target} - {θ}_{i }}{τ} ) ) \qquad ( 9 )$$

In this case, the following definitions hold:
i indicates a point in time i;
i+1 refers to a following point in time i+1;
Δt is the time span between two steps i and i+1 following one after the other; and
c₁ is a constant control parameter, in [W/K].

Here, thus, the heating power fed to the temperature sensor 12 is related to the difference between the current rate of change and the rate of change predetermined for the target-state.

Of course, the heating power Qᵢ₊₁ calculable from Equation (9) for the point in time i+1 represents only one possibility for achieving an ideal rate of change for the purpose of matching temperature to the target temperature value. However, any selectable form of embodiment is confronted with the problem that the time constant τ is not constant but instead is dependent in high degree on the flow rate of the measured medium through the pipeline 2. This is reflected in the heat transfer coefficient h from Equation (2). As a result, the time constant τ is not determinable. There follows a description of how a relatively more exact value for the time constant τ can be calculated.

As already said, the time constant τ can be exactly described via Equation (2). If steady state has been reached, then the following equation holds:

$$h \cdot A = \frac{Q}{{θ}_{target}} \qquad ( 10 )$$

During transient conditions, however, this relationship does not hold. Rather, the following holds during transient conditions:

$$h \cdot A \approx \frac{Q}{{θ}_{target}} \qquad ( 11 )$$

By placing Equation (2) in Equation (1), the following relationship is obtained:

$$τ \approx m \cdot {c}_{p} \cdot \frac{{θ}_{target}}{Q} \qquad ( 12 )$$

In this case, m and cₚ are material constants, which are independent of the physical conditions reigning in the process. However, the values of these variables are usually not known exactly. In order, nevertheless, to come to an estimate for the value of the time constant τ, as already described above, for example, the following estimate is used for the time constant τ:

$$τ ∝ \frac{{θ}_{target}}{{Q}_{i}} . \qquad ( 13 )$$

With the help of this estimate, application of a method of the invention permits significant improvement of the measuring accuracy of a flow measuring device during transient events.

### LIST OF REFERENCE CHARACTERS

1 apparatus of the invention
2 pipeline/measuring tube
3 measured medium
4 nozzle
5 housing
6 temperature measuring element
7 transmitter
8 connecting line
9 screw thread
10 control/evaluation unit
11 first temperature sensor
12 second temperature sensor
13 heating unit

1-7. (canceled)

8. A method for control of a thermal, or calorimetric, flow measuring device, which ascertains and/or monitors, by means of two temperature sensors, the flow of a measured medium flowing through a pipeline or a measuring tube in a process, comprising the steps of:
ascertaining the current temperature (Tᵢ) of the measured medium at a point in time (tᵢ) via a first temperature sensor;
supplying to a second temperature sensor, a defined heating power (Qᵢ) which is so sized, that a predetermined temperature difference (Θ_{target}) is obtained between the two temperature sensors; and
ascertaining, in the case of a deviation (Θ_{target}−Θᵢ) of the current temperature difference (Θᵢ) measured in the actual-state from the temperature difference (Θ_{target}) predetermined for the target-state, at a following point in time (tᵢ₊₁), the heating power (Qᵢ₊₁) supplied to the heatable temperature sensor, wherein:
the heating power (Qᵢ₊₁) is ascertained taking into consideration physical conditions in the process, which are reflected in a time constant (τ).

9. The method as claimed in claim 8, wherein:
the time constant (τ) dependent on the physical conditions in the process is determined by the following estimation:
$$τ ∝ \frac{{θ}_{target}}{{Q}_{i}} [ sec ]$$
where θ_{target} is a predetermined temperature difference, in [° C.], between heated temperature sensor and unheated temperature sensor, and
Qᵢ is a heating power, in [W], supplied to the heated sensor at point in time tᵢ.

10. The method as claimed in claim 8, wherein:
the time constant (τ) dependent on the physical conditions in the process is determined by the following estimation:
$$τ ∝ \frac{{θ}_{i}}{{Q}_{i}} [ sec ]$$
where
θᵢ is the current temperature difference, in [° C.], between heated temperature sensor and unheated temperature sensor, and
Qᵢ is the heating power, in [W], supplied to the heatable temperature sensor at the point in time tᵢ.

11. The method as claimed in claim 9, wherein:
when the current temperature difference (Θᵢ) measured in the actual-state deviates from the temperature difference (Θ_{target}) predetermined for the target-state, the rate of change for the supply of the heating power (Qᵢ₊₁) for compensating the deviation (Θ_{target-Θ}ᵢ) is so determined, that the system ‘temperature-sensor−measured-medium reaches the target-state (Θ_{target}) as rapidly as possible.

12. The method as claimed in claim 11, wherein:
wherein the rate of change for reaching the target-state (Θ_{target}) is calculated via the following estimation:
$${( \frac{\partial θ}{\partial t} )}_{target} = \frac{{θ}_{target} - {θ}_{i}}{τ}$$

13. The method as claimed in claim 12, wherein:
when the current temperature difference (Θᵢ) measured in the actual-state deviates from the temperature difference (Θ_{target}) predetermined for the target-state, the rate of change for the supply of the heating power (Qᵢ₊₁) is determined as a function of the difference between the rate of change of the current temperature difference and an optimum rate of change
$${( \frac{\partial θ}{\partial t} )}_{target} = \frac{{θ}_{target} - {θ}_{i}}{τ}$$

14. The method as claimed in claim 12, wherein:
the rate of change for supply of the heating power is calculated as a function of the difference between the current rate of change of the temperature difference and an optimum rate of change according to the following formula:
$${Q}_{i + 1} = {Q}_{i} - {c}_{1} \cdot Δ t \cdot ( ( \frac{{θ}_{i} - {θ}_{i - 1}}{Δ t} ) - ( \frac{{θ}_{target} - {θ}_{i }}{τ} ) )$$
where c₁, in [W·s/K], is a proportionality constant dependent on the control unit and Δt, in [s], is the length of time between two measurements following one after the other.
